(19) United States
(12) Patent Application Publication
(10) Pub. No.: US 2018/0030856 A1
(43) Pub. Date: Feb. 1, 2018

(54) Liner Element of a Turbomachine and Correspoding Connection Assembly

(71) Applicant: MTU Aero Engines AG, Muenchen (DE)

(72) Inventors: Alexander Kloetzer, Fuerstenfeldbruck (DE); Manfred Feldmann, Eichenau (DE)

(21) Appl. No.: 15/653,707

(22) Filed: Jul. 19, 2017

(30) Foreign Application Priority Data
Jul. 27, 2016 (DE) DE102016213813.8

(51) Int. Cl. F01D 25/24; B21D 22/20

(52) U.S. Cl. CPC F01D 25/246; B21D 22/20; F05D 2220/32; F05D 2240/14; F05D 2260/231; F05D 2300/10; F05D 2300/603; F05D 2230/20

(57) ABSTRACT

A liner element (10), in particular a heat shield element or casing element, of a turbomachine, in particular a gas turbine, including a fastening portion (12) having at least one bore (14-1, 14-2) through which a connection unit (42) having, in particular a pin-type or bolt-type form, is introducible along a bore axis (BA); a liner portion (16) that adjoins the fastening portion (12); the fastening portion (12) and the liner portion (16) being formed in one piece, and having an annular or ring segment shape. The bore (14-1, 14-2) is provided in a depression (24-1, 24-2) formed in the fastening portion (12), the depression (24-1, 24-2) being essentially formed concentrically about the bore (14-1, 14-2).

This claims the benefit of German Patent Application DE 102016213813.8, filed Aug. 1, 2016 and hereby incorporated by reference herein.

The present invention relates to a liner element, in particular a heat shield element or casing element, of a turbomachine, in particular a gas turbine, including: a fastening portion having at least one bore through which a connection unit having, in particular a pin-type or bolt-type form, is introducible along a bore axis; a liner portion that adjoins the fastening portion; the fastening portion and the liner portion being formed in one piece, and having an annular or ring segment shape.

### BACKGROUND

When liner elements formed, in particular as thin-walled components, preferably of a sheet metal, are fastened by rivets or screws, the problem regularly arises that, on the one hand, substantial vibrational stresses and, on the other hand, significant temperature fluctuations and mechanical stresses can occur. Accordingly, the fastening used for these liner elements should have very low tolerances, be able to withstand high loads and compensate for large thermal expansions. Therefore, very high manufacturing accuracies are required. Disk springs are typically used to compensate for manufacturing tolerances. However, they take up installation space and greatly limit the material selection.

Thermal expansions of liner elements can often only be compensated by using what are commonly known as sliding fits. They must have a certain minimum clearance to allow for a shifting of components relative to each other in response to temperature fluctuations. However, this leads to a less precise fastening of components so that they can be excited to vibrate. Such vibration increases wear and can also lead to failure of such a component or liner element.

A liner element in the form of a heat shield is known from World Patent Application WO 2015/102702 A, specifically from FIG. 2.

### SUMMARY OF THE INVENTION

It is an object of the present invention to provide a liner element that will withstand substantial vibrational and mechanical stresses and, at the same time, compensate for thermal expansions.

In the case of a liner element, it is achieved, in particular by providing the bore in a depression formed in the fastening portion, the depression being essentially configured concentrically about the bore.

The annular or ring segment-shaped embodiment of the liner element is in relation to the machine axis of the turbomachine. The concentric embodiment of the depression refers to a bore axis that extends centrally through the bore. Relative to the turbomachine, the bore axis may extend parallel to the axial direction thereof or parallel to the radial direction or also obliquely relative to these two directions.

An integrally formed resilient element is created by providing a depression in the fastening portion. Accordingly, installing such a liner element reduces the need for component parts. In particular, fewer or no disk springs are needed. The resilient effect thereof makes it possible for the depression to absorb vibrations, without the vibrations inducing a significant movement of connected components relative to each other. This reduces the wear the liner element, respectively a part connected thereto, is subject to.

The depression may have a crimped form. However, such a crimp does not have a groove-like or distinctly elongated shape, but is configured to be circular, elliptical or oval.

The bore may have a circular or elongated hole shape. In the case of a circular bore, which may also be referred to as a round hole, the connection unit provides a close fit for the liner element on another component. When the bore has an elongated hole shape, the liner element is movable therealong relative to the connection unit, making it possible to compensate for thermal expansions, in particular. An elongated bore may provide a sliding fit.

In relation to the bore axis, the depression may have an axial depth that corresponds approximately to 0.9 to 1.5 times a thickness of the fastening portion. This makes it possible to provide a depression that takes up little installation space. Furthermore, depending on the depth, the potential spring deflection may be adjusted, in particular along the bore axis.

The depression may have a rim portion that surrounds the bore, the rim portion being essentially formed parallel to a surface of the fastening portion surrounding the depression. The purpose of the rim portion, in particular is to provide a bearing surface that extends around the bore and enables the fastening portion to be supported on another component.

The liner element may include at least two bores, each having a depression; in the area of the bores, the fastening portion having a height extending in a surface plane of the fastening portion that is greater than the height between two adjacent bores. In relation to an annular or ring segment-shaped embodiment, a plurality of circumferentially spaced bores may be provided in the fastening portion. In this context, adjacent bores may have the same shape or differ from one another. For example, a bore may be circularly shaped as a close fit, and one or a plurality of adjacent bore(s) may be elongated hole-shaped as sliding fit(s).

The liner element may be made of a sheet metal or of carbon fiber-reinforced plastic. The depression may thereby have two curvatures in different directions. Thus, extending from a surface of the fastening portion, the depression may be formed in a type of S-shaped sequence of two curvatures, so that the rim portion already mentioned above resides on a different level than the surface of the fastening portion. In the case of a sheet metal, the bore may be produced by deep drawing.

The present invention also relates to a connection assembly in a turbomachine, in particular in a gas turbine between a liner element described above and another component of the turbomachine, a connection unit joining the component and the liner element to one another in the area of the at least one bore of the fastening portion of the liner element. The fastening portion is thereby configured more closely to the further component in the area of the depression around the bore than outside of the depression, and at least one washer, which is in contact with the fastening portion, is configured around the connection unit.

Two washers, between which the fastening portion is accommodated, may be configured around the connection unit, one of the washers engaging on the further component.

The connection unit may be a riveted joint or a bolt connection, in particular a bolt-and-nut connection.

A spacer sleeve may be configured around the connection unit in the area of the depression, on the side of the fastening portion facing away from the further component.

### BRIEF DESCRIPTION OF THE DRAWINGS

The present invention will be explained exemplarily in the following with reference to the enclosed figures and without being limited thereto.

FIG. 1 shows a specific embodiment of a liner element in a simplified and schematic perspective view, in particular from an oblique front view oriented towards an installation position in a gas turbine.

FIG. 2 shows the liner element of FIG. 1 in another simplified and schematic perspective view, in particular from an oblique rear view oriented towards an installation position in the gas turbine.

FIGS. 3A and 3B show a plan view and a sectional view through a depression of the liner element.

FIG. 4 shows a sectional view of a connection assembly having a liner element according to the present invention.

### DETAILED DESCRIPTION

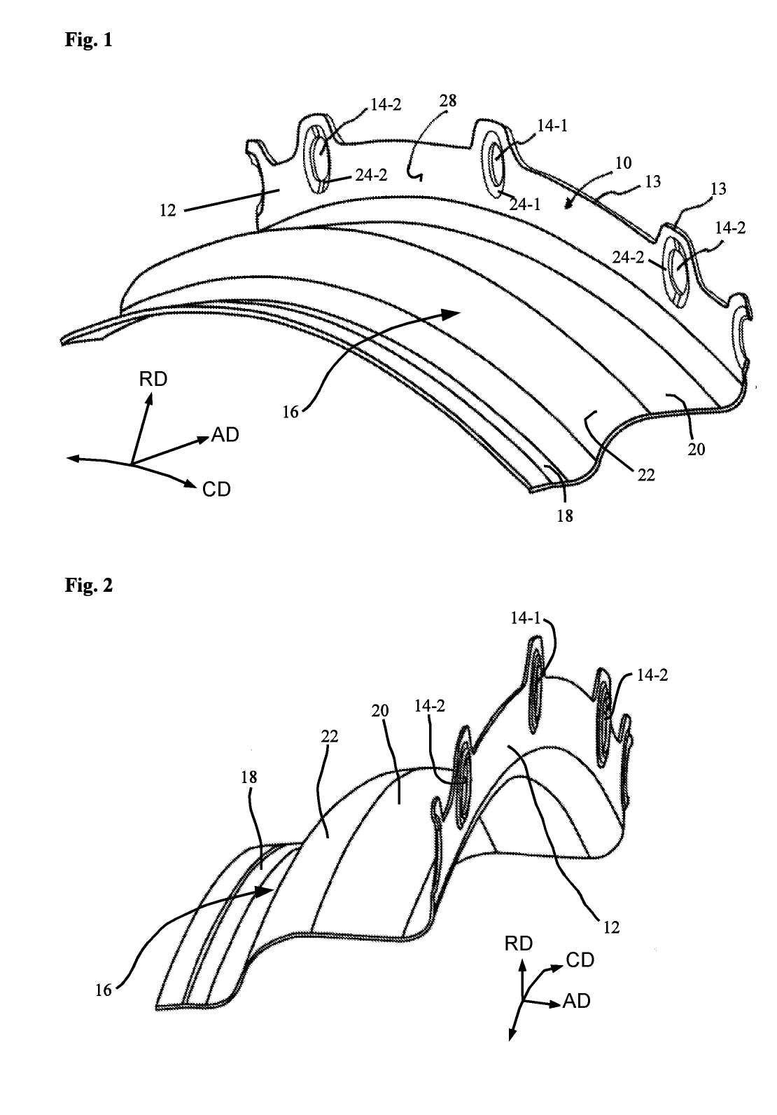

FIGS. 1 and 2 show a liner element 10 essentially having an annular or ring segment shape. In the present example, liner element 10 is a protective heat shield of a gas turbine in the turbine section thereof. However, the liner element is not limited to a protective heat shield, but may also be a different component of a gas turbine, such as a covering or encasing liner element, for example, a casing part or the like.

Liner element 10 includes a fastening portion 12 in which a plurality of bores 14-1, 14-2 are provided. Adjoining fastening portion 12 is a liner portion 16. Fastening portion 12 and liner portion 16 are joined together in one piece. In the present specific embodiment, fastening portion 12 extends along circumferential direction CD and in radial direction RD in relation to the installed position thereof in a gas turbine, these directional indications being in relation to a machine axis of the gas turbine. Liner portion 16 may have a radially inner portion 18 and a radially outer portion 20 that are joined to one another by an intermediate portion 22. The liner portion extends along circumferential direction CD and axial direction AD, so that it is essentially oriented orthogonally to fastening portion 12. In the area of bores 14-1, 14-2, a rim 13 of fastening portion 12 extends radially further outwardly than between two adjacent bores. In other words, the height of fastening portion 12 is variable and is greater in the region of bores 14-1, 14-2 than in the region between two bores 14-1, 14-2.

It should be appreciated, however, that the fastening portion does not necessarily need to be oriented as shown in FIGS. 1 and 2. Rather, the fastening portion may also extend obliquely to radial direction RD and to the axial direction. It is also conceivable that the fastening portion extends along axial direction AD and circumferential direction CD. Also, the orientation of liner portion 16 is not limited to the representation of FIGS. 1 and 2. A continuous liner portion that extends obliquely to axial direction AD, for example, and forms a type of cone is also conceivable, for example.

In the present example, bore 14-1 is formed as a circular round hole. Bores 14-2 are formed as elongated holes. Respective depressions 24-1 and 24-2 are formed in fastening portion 12 about bores 14-1 and 14-2. Depressions 24-1, 24-2 thereby have a rim portion 26 surrounding respective bore 14-1, 14-2. Bores 14-1, 14-2 are adapted for receiving a connection unit, such as a bolt, a screw, in particular also a bolt-and-nut connection or a rivet.

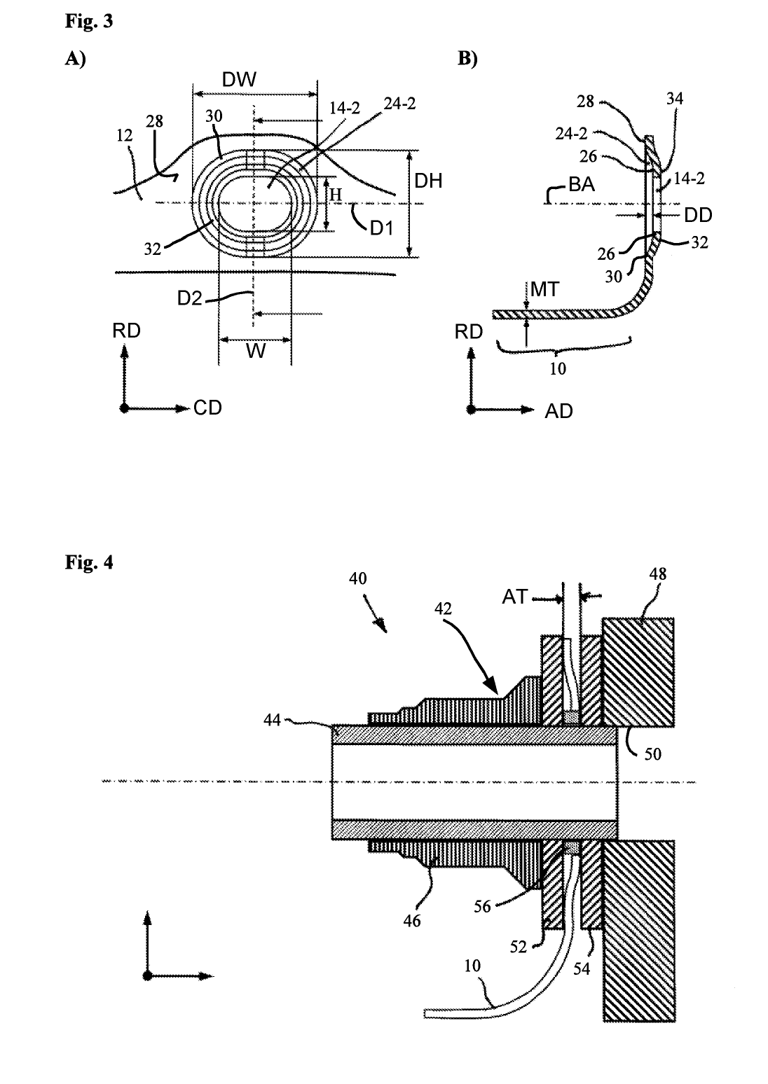

From the plan view in accordance with FIG. 3A) and the corresponding sectional view of FIG. 3B), a bore 14-2 is shown exemplarily in the form of an elongated hole. It may thereby be elongated hole 14-2 shown in FIG. 1 to the left of bore 14-1, for example. Bore 14-2 has a bore axis BA which essentially passes centrally through bore 14-2. The bore axis essentially corresponds to an axis of a connection unit to be inserted into bore 14-2. In FIG. 3A, depression 24-2 is indicated in the form of concentric lines; these lines representing a type of contour lines. Extending from a front surface 28, which essentially lies in a surface plane of fastening portion 12 (corresponds to the drawing plane in FIG. 3A), depression 24-2 has a first, in particular convex curvature 30, and a second, in particular concave curvature 32. Bore 14-2 is bounded by rim portion 26, which, in relation to bore axis BO, radially inwardly adjoins second curvature 32.

Rim portion 26 is configured to be essentially parallel to surface 28 of fastening portion 12. In addition, by side 34 thereof which faces away from surface 28 and may also be referred to as rear surface of rim portion 26, rim portion 26 is adapted to rest against a component to be connected, such as a washer, a casing component or the like.

In the stress-relieved state, i.e., a state in which fastening portion 10 is not yet fastened, depression 24-2 has a depth DD that preferably has a distance from surface 28 that corresponds approximately to 0.9 to 1.5 times material thickness MT, in particular the plate thickness of liner element 10. In relation to bore axis BA, bore 14-2 extends in a first direction D1, which corresponds to circumferential direction CD in the specific embodiment when liner element 10 is properly installed. In addition, bore 14-2 extends in a second direction D2 that is orthogonal to first direction D1 and corresponds to radial direction RD in the specific embodiment when liner element 10 is properly installed. In first direction D1, bore 14-2 has a width B and, in second direction D2, a height H. In addition, in first direction D1, depression 24-2 has a width DW and, in second direction D2, a height DH.

In the case of an elongated hole, the ratio of width W to height H (W/H) of bore 14-2 is greater than one, and may preferably have a value of up to approximately two.

In the case of an elongated hole, the ratio of width W of depression 24-2 to width DW of bore 14-2 is greater than one, and may preferably have a value of up to approximately two.

The just aforementioned with reference to FIGS. 3A) and 3B) for an elongated hole-type bore 14-2 also holds analogously for a circular bore 14-1 and for a corresponding depression 24-1 (FIG. 1). In the case of a circular bore 14-1, the ratio of width W to height H of bore 14-1 is one. It should also be appreciated that the ratios described for elongated hole 14-2 of width W to height H are exemplary for the orientation shown here of elongated hole 14-2. Also conceivable is an elongated hole that is rotated by 90°, so that height H has a larger value than width W. In such a case, ratio W/H would assume a value of less than one.

FIG. 4 shows a sectional view of a connection assembly 40 having a liner element 10. The connection assembly includes a connection unit 42. In this example, connection unit 42 includes a threaded bolt 44 and a nut 46 bolted thereon. Threaded bolt 44 is also connected to a component 48, in particular received in a bore 50 thereof. Threaded bolt 44 is also conceivably joined in a material-to-material bond to component 48, for example welded thereto.

By bore 14-1 or 14-2 thereof, liner element 10 is placed over threaded bolt 44. In other words, threaded bolt 44 is inserted into the bore along bore axis BA of bore 14-1, 14-2. Depression 24-1, 24-2 of the bore is accommodated between two washers 52, 54, the one washer 52 resting against nut 46, and the other washer 54 against component 48. Fastening portion 12 rests by side 34 of rim portion 26 against washer 54. To ensure that the depression is not flattened by pressure when the connection is made between liner element 10 and component 48, a spacer sleeve 56 is accommodated in bore 14-1, 14-2. Spacer sleeve 56 thereby has an axial thickness AT which, in the assembled state, essentially corresponds to an axial distance from surface 28 of fastening portion 12 to side 34 of rim portion 26 (FIG. 3B). In this context, axial thickness AT of the spacer sleeve may preferably be smaller than depth DD of the depression plus material thickness MT (FIG. 3B). A fastening of liner element 10 in a prestressed state in the area of bores 14-1, 14-2 is hereby possible due to the resilient effect of depressions 24-1, 24-2. Close fits or sliding fits may be provided, depending on the embodiment of bores 14-1, 14-2, so that, in addition to the secure fastening by connection unit 42, it is possible to determine whether a shifting of liner element 10 and component 48 relative to each other is to be made possible along an elongated bore 14-2.

Configuring depression 24-1, 24-2 in the area of bores 14-1, 14-2 eliminates the need for small-size parts, such as disk springs. By integrating depression 24-1, 24-2 in liner element 10, a resilient or compensating element is formed for connection assembly 40. Connection assembly 40 presented here damps vibrations and compensates for thermal expansions.

Liner element 10 may be a protective heat shield, for example, or some other casing element. Further component 48 illustrated in FIG. 4 may be a casing part, a type of frame or strut section or the like of the gas turbine. Besides the described bolt-and-nut connection, the connection unit may also be in the form of a rivet.

### LIST OF REFERENCE NUMERALS

10 liner element

12 fastening portion

13 rim

14-1 circular bore

14-2 elongated bore

16 liner portion

18 radially inner portion

20 radially outer portion

22 intermediate portion

24-1 circular depression

24-2 elongated hole-type depression

26 rim portion

28 surface

30 first curvature

32 second curvature

34 side of the rim portion

40 connection assembly

42 connection unit

44 threaded bolt

46 nut

48 further component

50 bore

52 washer

54 washer

56 spacer sleeve

1-13. (canceled)

14. A liner element comprising:
a fastening portion having at least one bore through which a connection unit is introducible along a bore axis;
a liner portion adjoining the fastening portion;
the fastening portion and the liner portion being formed in one piece and having an annular or ring segment shape, the bore being provided in a depression formed in the fastening portion, the depression being formed concentrically about the bore.

15. The liner element as recited in claim 14 wherein the depression has a crimped form.

16. The liner element as recited in claim 14 wherein the bore has a circular or elongated hole shape.

17. The liner element as recited in claim 14 wherein, in relation to a bore axis, the depression has an axial depth corresponding to 0.9 to 1.5 times a thickness of the fastening portion.

18. The liner element as recited in claim 14 wherein the depression has a rim portion surrounding the bore, the rim portion being formed parallel to a surface of the fastening portion surrounding the depression.

19. The liner element as recited in claim 14 wherein the at least one bore includes at least two bores, each having a respective depression and in an area of the bores, the fastening portion has a height extending in a surface plane of the fastening portion, the height being greater than a further height between two adjacent bores.

20. The liner element as recited in claim 14 wherein the liner element is made of a sheet metal or of carbon fiber-reinforced plastic.

21. The liner element as recited in claim 14 wherein the depression has two curvatures in different directions.

22. The liner element as recited in claim 20 wherein the liner element made of the sheet metal and the depression is produced by deep drawing the sheet metal.

23. The liner element as recited in claim 14 wherein the connection unit is a pin or bolt.

24. A heat shield element or casing element of a turbomachine comprising the liner element as recited in claim 14.

25. A heat shield element or casing element of a gas turbine comprising the liner element as recited in claim 14.

26. A connection assembly in a turbomachine, comprising:
a liner element as recited in claim 14, the connection unit and another component of the turbomachine, the component and the liner element being joined to one another in an area of the at least one bore of the fastening portion of the liner element by the connection unit, wherein the fastening portion configured more closely to the further component in a further area of the depression around the bore than outside of the further area of the depression, and at least one washer, the washer being in contact with the fastening portion and configured around the connection unit.

27. The connection assembly as recited in claim 26 wherein the at least one washer includes two washers, between which the fastening portion accommodated between the two washers, the two washers being configured around the connection unit, one of the washers engaging on the further component.

28. The connection assembly as recited in claim 26 wherein the connection unit is a riveted joint or a bolt connection.

29. The connection assembly as recited in claim 26 wherein the connection unit is the bolt connection, the bolt connection being a nut-and-bolt connection.

30. The connection assembly as recited in claim 26 wherein a spacer sleeve is configured around the connection unit in the area of the bore.
